(19) United States
(12) Patent Application Publication
(10) Pub. No.: US 2004/0195339 A1
(43) Pub. Date: Oct. 7, 2004

(54) Micro card and passive commutate device suitable for micro card

(75) Inventors: Chia-Li Chen, Hsin-Dien City (TW); Hsiang-An Hsieh, Hsin-Dien City (TW)

Correspondence Address: TROXELL LAW OFFICE PLLC, SUITE 1404, 5205 LEESBURG PIKE, FALLS CHURCH, VA, 22041, US

(73) Assignee: Carry Computer Eng. Co., Ltd.

(21) Appl. No.: 10/464,754

(22) Filed: Jun. 19, 2003

(30) Foreign Application Priority Data
Apr. 2, 2003 (TW) 092205198

(51) Int. Cl. G06K 7/00; G06K 19/06

(52) U.S. Cl. 235/492; 235/486

(57) ABSTRACT

A micro card and the passive commutate device suitable for micro card, wherein the micro card is a micro card designed in a theory of micro and is configured with micro controller and substrate of repeating read-write memory and transmit part connect electrically with the substrate. The transmit part of the micro card is designed into a universal interface to support the transfer of sign of interface of various application device. The micro card link with a pre-set passive commutate device, a first standard interface disposed on the passive commutate device. The first standard interface is for memory card interface, and connect electrically with universal interface and couple with memory card of application device. By micro card sense automatically, judge the interface type supported by the passive commutate device to switch to corresponding work model to save outer date to repeating read-write memory of micro card.

5.(1). The representative drawing of the present invention is FIG. 2.

(2). The brief description of the representative symbol of the representative drawing of the present invention:

1: micro card

103: transmit part (universal interface)

2. passive commutate device

20: main body

201: first standard interface

202: receive zone

203: second standard interface

### FIELD OF PRESENT INVENTION

The present invention relates to a repeatable write-read micro card having multiple work model, especially to a micro card can support various memory card or memory device interface.

### PRIOR TECHNOLOGY

Because the electric technique develop flourishly, a person need save media that have big memory capacity, more rapid transfer ratio, and the volume is thinner and the weight is lighter to save private data and for the convenience of carry. For the present, among the save medias having the above-mentioned characters, electrical memory card-the new pet of the memory media is the best, the memory media card is developed utilizing the semi-conductor technology and has the above-mentioned characters: the convenience of taking, electricity-saving, data-saving, velocity of data-transfer, repeating read-write, and anti-quake and anti-damp. Just because the electric memory card has the predominant using characters and futures, so many international electric manufactures such as Sony, TOSHIBA, SIEMENS, Panasonic, and SanDisk develop and launch in succession various types memory cards, such as PC card(PCMCIA ATA Flash Card), CF card(Compact Flash Card), SM(Smart Media Card), MMC card(Multi-Media Card), MS card(Memory Stick Card), SD card (Secure Digital Card) used in the portable digital electrical products. Because the standard of above-mentioned electrical memory cards has become more and more multiple, manufactures failed to unify the standard manufacture specification, so these manufactures develop specific interface suit for their own memory card based on their own various new consumerial electrical device, portable device or information electrical appliance, by these specific interface save the digital information saved in their own memory card to make their own memory card take up the advantageous on the market. If consumer bought some one digital product will be limited by standard of memory card that has been not be unified. When the consumer waned to upgrade the memory card save capacity or buy some more advantage digital product must consider priority digital products produced by the manufacture and must buy them painfully to pay for it (that is always is expensive), otherwise will face embarrass of digital product can not cooperate with memory card, and if consumer use the memory card in outer system without said memory card interface, such as consumer always need table computer or notebook will be disturbed by cannot transfer date and realize switch function, so will result many inconvenience of using. To resolve said problem of failing unify memory card standard, to some manufactures develop read or commutate device having multi or common grooves that can support various standard memory card read-write to eliminate the inconvenience of consumer can not use various memory card on the computer mainframe.

However the read or commutate device suitable for various memory card only be used in computer mainframe, can not be used in portable digital products, so if consumer use different digital products that produced by different manufactures must buy additionally specific memory card for attached digital products, that will result the inconvenience of using for consumer and the waste of cost of hardware.

In addition, traditional computer mainframe and/or digital product have universal standard USB interfaces. The computer mainframe and/or digital product can extend interface of surround device by these interfaces. Because USB interface has the advantages: rapid transfer ratio, easily-mount, hot-plug, support various surround devices, so for the present, all the PC system and notebook system have a expand interface. The surround device comprise: input device(keyboard, mouse, rocker), memory device( hard CD machine, soft CD machine, disk machine, silicon disk machine), output device(digital phone), communicate device(USB wireless circuit device, USB wire) or digital products.

Although we disclose the prior technology and shortcoming thereof above, many invent object haven't been considered in above-mentioned conference information, for example:

1. Can design a memory card suitable for above-mentioned various memory card interface standard?

2. Can the memory card be designed in micro theory and the volume of it be smaller than impact circuit?

3. Can the memory card be designed into a memory card that can support USB interface standard?

### SUMMARY OF THE INVENTION

The present invention provides a micro card, which is designed by the inventor after study and test to overcome the above-mentioned shortcomings. The micro card is the great invention that is convenient for the information communication for the consumers.

The main object of the present invention is to provide a micro card that can simulate various types of memory card interface by appropriate mechanism to support the digital signs that transmitted by various digital products, computer system port or surround devices.

Another object of the present invention is to provide a micro card that made in a micro concept design. The micro card can connect with passive commutate device with various interfaces, size, types according to the using requirement. After the micro card arranged with the passive commutate device, the two will be a micro card that can be used in various memory card standard.

Another object of the present invention is to provide a micro card that can support various digital products having USB interface, computer system port or surround device by appropriate mechanism to improve the convenience of using.

To release the said or other objects and function, one of the micro card according to the present invention comprises at least a substrate having micro controller and at least one repeatable read-write memory, and a transmit part electrical connected with substrate, these elements are designed in micro concept design, wherein the transmit part is designed into a universal interface and make the micro card can support the signs that transmitted by the memory card interface of various digital device by the automatic sense, switch by micro controller.

And, the present invention provide a passive commutate device that can support the micro card, the passive commutate device has first standard interface and a receive zone, the first standard interface may be SD or MS series or USB interface and other types memory cards and can couple with specific memory interface of outer device; The receive zone is used for receive micro card. The micro controller of the micro card sense automatically and judge the passive commutate device support which type memory card interface and switch to corresponding work model and save the outer data into the micro card.

Manufacture and connect the micro card and passive commutate device according to above-mentioned manner, i.e. simulate traditional memory card on the electrical standard and interface, size and sever as memory media of various digital products, computer system port or surround device.

To make the said and other object, character and advantages of the present invention clear, the following will describe the invention according to a preferred embodiment, with reference to the accompanying drawings.

### DETAIL DESCRIPTIONS OF THE EMBODIMENT(S)

As illustrated in FIG. 1, a micro card 1 that invented by the inventor, the entire body at least comprises a substrate 10 having micro controller and having at least one repeatable read-write memory 102, and transmit part 103 electrically connected with substrate 10; the entire construct of said micro card is designed in micro concept make the entire size lighter, thinner, shorter, smaller than the traditional portable save media (such as SD, MS series memory card and other types of memory cards).

The said transmit part 103 is designed into a universal interface and can support multiple memory interfaces of digital device, such as interfaces that belong specifically to SD or MS series or other types of memory cards. The micro card 1 according to the present invention at least need corresponding transmit pins(such as pins for power, pins for data transmission, pins for transmit control sign) on its universal interface 103 to satisfy the different need of outer interface transmit signs.

But the design of position of feet cannot support various memory card interfaces, that is because the number of pins must be reduced as possible as to realize the micro object. The design manner enable some pins electrical connect with these memory card interfaces in such a manner of one pin corresponding to multiple pins.

For example, SD memory card interface, although the interface is 9 pins, some pins used as transfer cathode power, so the micro card according to the present can used as transfer cathode power by a single pin, and connect all the cathode power of the SD interface on the electrical connect with some pins in such a manner of one pins corresponding to multiple pins.

Such design can reduce the number of the unnecessary pins and can support the necessary signs that transmitted by multi memory card interfaces.

In addition, the micro card 1 of the present invention support the interface having little pins in addition to support said memory card interface having more pins. The interface having little pins, such as standard interface—USB interface (most popular interface) having 4 pins, when micro card 1 electrically connect with the interface, some pins are disable, some pins electrical connect with the USB interface in such a manner that one pin corresponding to multiple pins, so the micro card can support all the signs that transmitted by USB interface.

And, the electrical connect manner of the said interface is distributed by micro controller 101 disposed on substrate 10 of micro card 1, sense automatically memory interface style of digital device and switch to corresponding work model that supported by the automatic sense or switch function of the micro controller 1, wherein the corresponding work model correspond to data or sign transmitted in addition to correspond to various interface having said transfer model, enable it have corresponding model in instruction decode, performance.

Thereby, micro card 1 is up to the transfer demand of various memory card interfaces and corresponding work model, so can support various memory card interface in the electric standard. And, because micro card 1 have repeating read-write memory card 102 that is rapid flash memory of non-volatile memory, said rapid flash memory has the function of erase, write data electrical repeatedly, so make said micro card 1 have save function and to substitute traditional memory card and be used in various digital device.

Wherein, because entire micro card 1 is micro concept design, to make the micro card be up to the contain scope of traditional memory card interface in the interface and size standard, so the micro card 1 be disposed in the passive commutate device (FIG. 2) adopted in the present invention, said commutate device can support the micro card. Beause of the passive commutate deviceMicro card 1 is up to memory card similar to SD, MS series and other types of memory card and USB memory device.

As shown in FIG. 2, the passive commutate device that can support micro card have a main body 20, the said main body 20 have a first standard interface 201 and receive zone 202, wherein said first standard interface 201 is coupled symmetrically to memory card interface of various digital devices (in a manner of one pin corresponding to one pin), and said receive zone receive said micro card 1 so as to universal interface 103 of micro card 1 can connect electrically with first standard interface 201.

In an alternative embodiment of passive commutate device 2 according to the present invention, a second standard interface 203 is pre-disposed on the appropriate position abut receive zone 202, the interface is same as the interface of micro card(i.e. the universal interface 103 shown in FIG. 1). The second standard interface 203 couples with universal interface 103 of micro card 1, and connects electrically with first standard interface 21 symmetrically incomplete (in such a manner that some pins in the manner of one pin corresponding to multiple or some pins are disable), whereby, when micro card is in receive zone 202, micro card can transmmit sign introduced from outer to first standard interface 201 by said second standard interface 203.

Please refers to FIG. 3, passive commutate device according to the present invention is designed into similar SD memory card, FIG. 3 illustrates the perspective of the embodiment of the passive commutate device, wherein passive commutate device 3 has same number of pins and same construct style as the SD memory card's. Passive commutate device couples symmetrically with SD memory interface of outer digital device. When micro card is received in receive zone 32 of passive commutate device 3, the arrangement of the two make a SD memory card, so make the whole of it can be locked in corresponding digital device, such as digital camera, PDA to provide for digital camera.

In addition, the passive commutate device can be designed into similar interface MS series memory card (shown as FIG. 4) in style and size, wherein passive commutate device 4 have the same number of pins and structure as MS series memory card. Passive commutate device 4 couples symmetrically with MS series memory card interface of outer digital device. When micro card 1 is received in receive zone 42 of passive commutate device 4, the arrangement of the two make a SD memory card, so make the whole of it can be locked in corresponding digital device, to provide for digital camera.

To connect with computer system of USB interface, electrical appliance or portable digital device, the passive commutate device adopted in the present invention can designed into similar to interface of USB memory device (shown in FIG. 5), wherein passive commutate device 5 have the same number of pins and structure as USB memory device. Passive commutate device 5 couples symmetrically with USB interface of outer digital device, when micro card is received in receive zone 52 of passive commutate device 5, arrangement of the two make a USB memory device. Wherein, passive commutate device 5 can be designed same as traditional thumb (that is popular USB portable memory device), but because when connect with digital interface having USB interface, most of them do not need be enclosed in device, and if only it can receive micro card 1 on the body is enough.

Please refers to FIG. 3, FIG. 4 and FIG. 5, the manner of disposing the micro card 1 into various passive commutate device is set a groove (for example groove 30 in FIG. 3, groove 40 of FIG. 4 and groove 5 of FIG. 5), the groove extend from the groove to receive zone, by this micro card 1 can be disposed in passive commutate device from groove port.

Said micro card 1 is disposed in passive commutate device in groove manner, but that's not limited by this manner, and other manner can be adopted, such as lift the cover, to dispose micro card 1 into passive commutate device of receive zone.

In summary, the present has been described above with reference to a preferred embodiment, but that not be used for limit the present invention, any person skilled in this art can make various modifications without departing from the scope of the invention, so the scope of the invention is defined by the appended claims.

### THE BRIEF PRESCRIBE OF THE DRAWINGS:

FIG. 1 is structure view of the micro card according to the present invention;

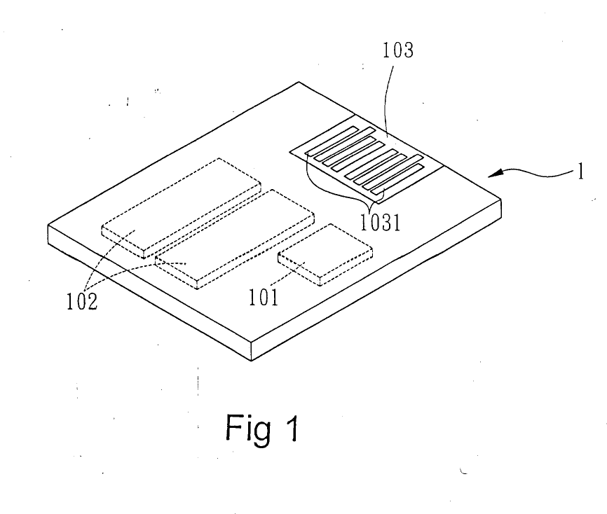

FIG. 2 is structure view of the passive commutate device according to the present invention;

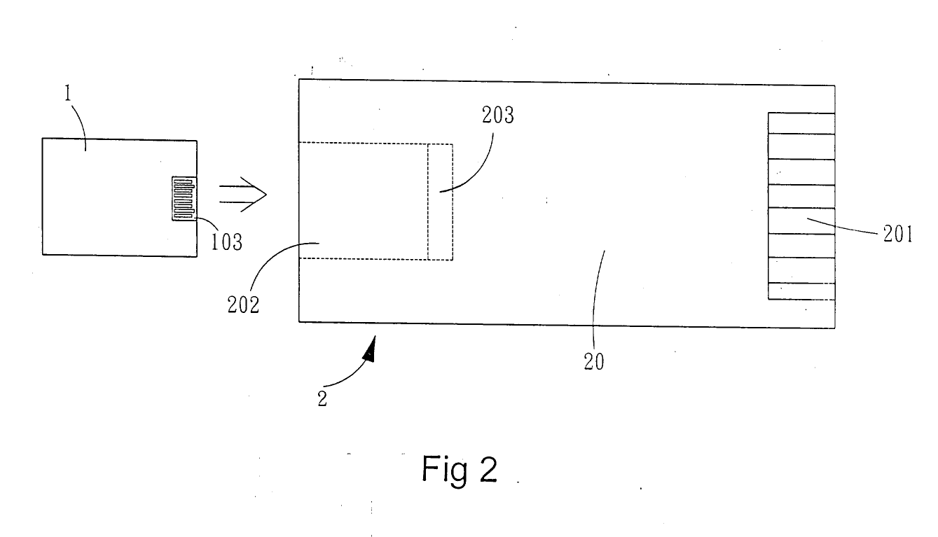

FIG. 3 is an arrangement view of the micro card according to the present invention with a passive commutate device similar to SD memory card;

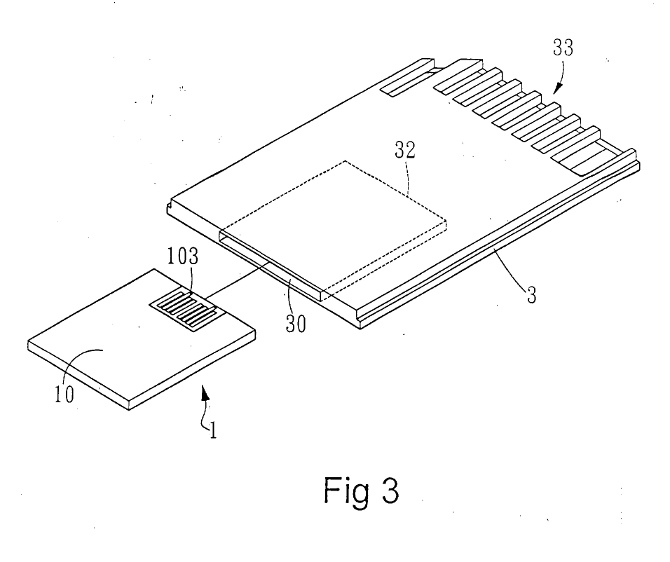

FIG. 4 is an arrangement view of the micro card according to the present invention with a passive commutate device similar to MS memory card;

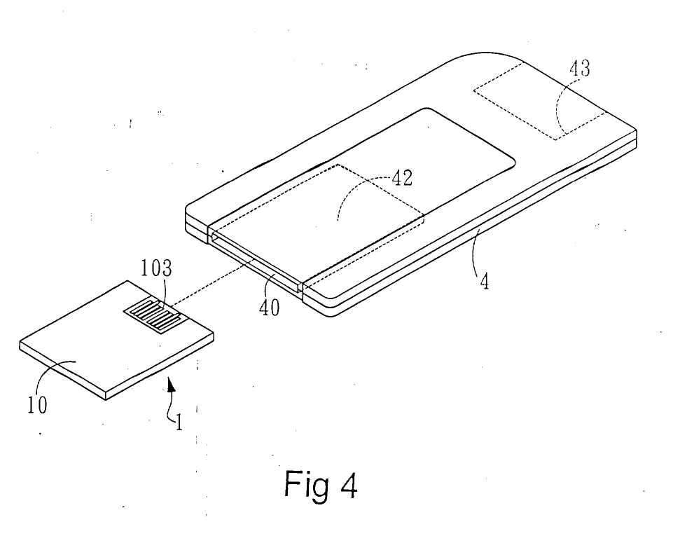

FIG. 5 is an arrangement view of the micro card according to the present invention with a passive commutate device similar to USB memory card;

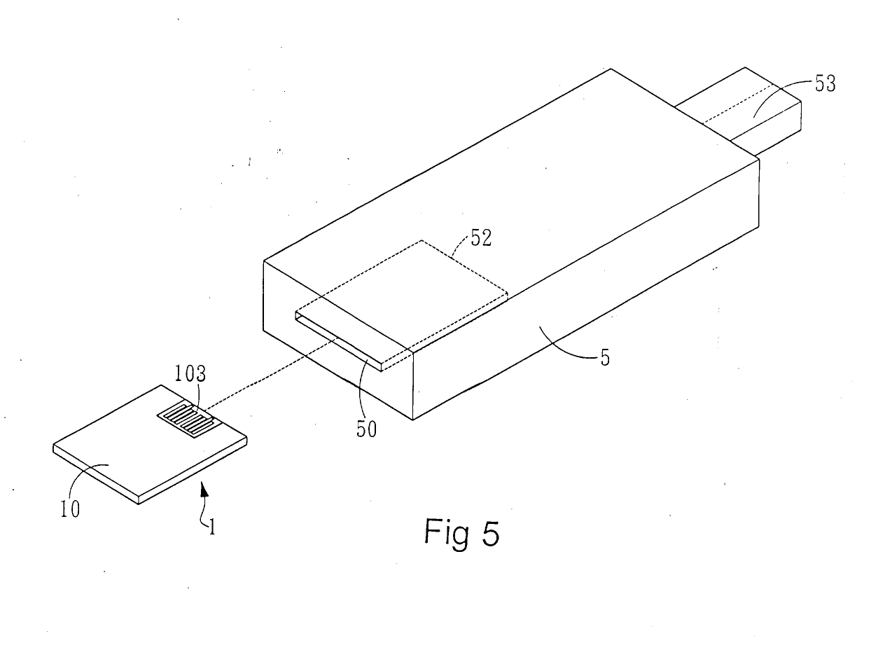

1: Micro card

10: substrate

101: micro controller

102: repeated-write memory

103: transmit part(universal interface)

1031: universal interface pin

2: passive commutate device

20: body

201: first standard interface

202: receive zone

203: second standard interface

3: passive commutate device similar to SD memory card

30: groove

32: receive zone

33: SD standard interface

4: passive commutate device similar to MS memory card

40: groove

42: receive zone

43: MS standard interface

5: passive commutate device similar to USB device interface

50: groove

52: receive zone

53: USB standard interface

What is claims is:

1. A micro card, being designed entirely in a manner of micro concept, comprising at least a substrate having micro controller and at least one repeatable read-write memory, and a transmit part electrical connected with substrate, these elements are designed in micro concept design, wherein the transmit part is designed into a universal interface and make the micro card can support the signs that transmitted by the memory card interface of various digital device by the automatic sense, switch by micro controller.

2. The micro card according to claim 1, wherein said universal interface support interface belongs specially to SD or other types of memory cards.

3. The micro card according to claim 1, wherein said universal interface support interface belongs specially to MS or other types memory cards.

4. The micro card according to claim 2 or 3, wherein the connect manner of said universal interface with said memory card interface is electrically connect with some pins in such a manner of one pin correspondint to multiple pins.

5. The micro card according to claim 1, wherein said universal support interface belongs specially to USB memory device.

6. The micro card according to claim 5, wherein the connect manner of said universal interface with said USB interface is electrically connect with some pins is disable, and some pins in such a manner of one pin corresponding to one pin.

7. A passive commutate device supporting micro card, comprising a main body, said main body have a first standard interface and a receive zone, said first standard interface is disposed according to memory card interface style, and couple with interface of various digital device, said receive zone is for receive micro card, and make universal interface of said micro card electrically connect with said first standard interface.

8. The passive commutate device supporting micro card according to claim 7, wherein a second standard interface is disposed in appropriate position abut said receive zone, and couple with universal interface of said micro card, and electrically symmertically incomplete with said first standard interface.

9. The passive commutate device supporting micro card according to claim 7, wherein said first standard interface is designed into interface of SD or MS series or other types memory cards.

10. The passive commutate device supporting micro card according to claim 9,wherein said universal interface connect electrically to first interface with come pins in such a manner of one pin corresponding to multiple pins.

11. The passive commutate device supporting micro card according to claim 7, wherein said first interface is USB interface.

12. The passive commutate device supporting micro card according to claim 11, wherein universal interface connect electrically with said first interface in a manner that some pins are disable and some pins in such a manner that one pin to one pin.

13. The passive commutate device supporting micro card according to claim 7, wherein it is designed into interface similar to USB memory device.

14. The passive commutate device supporting micro card according to claim 7, wherein it is designed into interface similar to SD or MS series memory card.

15. A micro card and passive commutate device suitable for micro card, wherein, said micro card comprises a substrate having micro controller and having at least one repeatable read-write memory, and a transmit part electrically connected with substrate, these elements are designed in micro concept, wherein the transmit part is designed into a universal interface and make the micro card can support the signs that transmitted by the memory card interface of various digital device by the automatic sense, switch by micro controller.
A passive commutate device that can support the micro card, the passive commutate device having first standard interface and a receive part, the first standard interface may be SD or MS series or USB interface and other types memory cards and can couple with specific memory interface of outer device;
The micro controller of the micro card sense automatically and judge the passive commutate device support which type memory card interface and switch to corresponding work model and save the outer data into the micro card

16. The passive commutate device supporting micro card according to claim 15, wherein universal interface of said micro card is electrically connect unnecessary symmetrically with first standard interface.

17. The passive commutate device supporting micro card according to claim 16, wherein first standard interface is interface of SD or MS series or other types memory cards interface.

18. The passive commutate device supporting micro card according to claim 17, wherein the universal interface connect electrically with first standard interface with some pins in such a manner that one pin corresponding to multiple pins.

19. The passive commutate device supporting micro card according to claim 16, wherein said first standard interface is USB interface.

20. The passive commutate device supporting micro card according to claim 19, wherein said universal interface connect electrically with first interface in such a manner of some pins is disable and some pins in a manner that one-to-one.
